(19) United States
(12) Patent Application Publication
(10) Pub. No.: US 2024/0188158 A1
(43) Pub. Date: Jun. 6, 2024

(54) DUAL BAND COMPOSITE RADIO FOR 6 GHZ

(71) Applicant: ARRIS Enterprises LLC, Suwanee, GA (US)

(72) Inventor: James R. Flesch, Doraville, GA (US)

(21) Appl. No.: 18/526,187

(22) Filed: Dec. 1, 2023

Related U.S. Application Data
(60) Provisional application No. 63/429,626, filed on Dec. 2, 2022.

(51) Int. Cl. H04W 76/15

(52) U.S. Cl. CPC H04W 76/15; H04W 88/08

(57) ABSTRACT

An access point device with a single radio can provide a 6 GHz fronthaul connection to a client device and a 6 GHz backhaul connection to a network device by utilizing a dual-channel composite radio. The dual-channel composite radio comprises a summation circuit for summing transmit signals from the network device and the client device. The output from the summation circuit is fed to a front-end module (FEM) that sends this output to the antenna. The FEM can also receive signals from the network device and the client device and send those signals to the FEM for transmission to a bandpass filter that separates the signals into distinct signals associated with the respective devices. In this way, the cost is reduced and resources are conserved by only requiring a single dual-channel composite radio in an access point device for providing 6 GHz connectivity.

### BACKGROUND

Generally, various wireless fidelity (Wi-Fi) client devices, such as altered realty (AR) devices, of a network can require low latency and increase bandwidth so as to provide acceptable quality of service (QoS) especially client devices that present altered realty content, including multimedia content, to an interactive user experience. An access point device can include multiple radios and associated interfaces so as to provide connectivity to such AR devices. However, generally access point devices include multiple radios to provide the 6 gigahertz (GHz) to the AR device and for a backhaul channel which can increase costs and burden available resources. Thus, there is a need for a dual band composite radio system for 6 GHz connectivity.

### SUMMARY

Generally, access to content by a wireless client device (referred to also as a client device) is limited by the network performance of the network as provided by an access point device. The access point device provides the interface between a content provider that provides augmented reality (AR) content and a client device (such as an AR device) in the network. For example, the emergence of high-resolution AR gaming simulations (which have corresponding high bitrate demands for variously compressed multimedia content) challenges in-site (such as in-home) Wi-Fi distribution both for absolute carriage capacity and the latency associated with packet dispatch and reception. The 6 GHz frequency band nicely addresses both of these challenges with the associated immense bandwidth and reliance on only two media access controls (MACs) allowance for unlicensed exploit of the spectrum (for example, Wi-Fi 6 and/or Wi-Fi 7). The general universal acceptance for both low-power indoor (LPI) and very-low power (VLP) transmission power levels suggests that a dual channel arrangement which marries VLP for local in-room distribution (and minimal external-room co-channel interference (CCI)) with either LPI or standard power 6 GHz whole-site or whole-home backbone would make for a potent combination in addressing both bitrate and latency concerns for high bitrate services, such as AR applications especially when provided in a single integrated package.

To create a smooth and optimized wireless connectivity system for a client device (such as an augmented reality device), for example, any of an immersive technology device (such as any of a virtual reality device, an altered reality device, a mixed reality device, etc.), an extended reality (XR) device (for example, a HMD XR device), any other AR device, or any combination thereof) (collectively referred to as an AR device), one or more aspects of the present disclosure provide a cost-effective media access control (MAC) system for adapting the 6 GHz spectrum for both backhaul and client-servicing duties by limiting the number of access point device radio chains required for handling the two wireless demands (on two different frequencies) using the common paradigm of one chain per transmission power level per 6 GHz channel. A tremendous advantage is obtained by selectively dual-purposing portions of the radio frequency (RF) chains. One or more aspects of the present disclosure provide novel solutions for providing a single composite radio for in-room dual-channel 6 GHz connectivity. A key dependent in the novel solutions is the realization that, for both low-noise amplifier (LNA) and power amplifier (PA), the superposition of energy from VLP onto an LPI chain amounts to −13 decibels (dB) (or 5%) of the existing chain RF carriage and this can be frequency division multiplexed (FDM) to a channel several hundred MHz away, producing a composite analog transmission signal which transmits on two different frequencies. Given that the analog portions of the radio chains can shoulder the burden of small differentials in analog energy, then digital signal processing (DSP) methodologies can be used to properly extract (or combine) the signaling required to support two 6 GHz channels at two different power levels using only one RF chain to power the two channels (two 4×4 solution can collapse to a single 4×4 solution or even to a 2×2 if bitrate requirements are adequately met with only two chains).

One or more aspects of the present disclosure, provide novel solution(s) for providing an improved quality of service (QoS)/quality of experience (QoE) for network devices (such as AR devices that require a low latency, high speed, and high bandwidth connection) by providing a dual-channel access point device that uses a dual-channel composite radio for providing 6 GHz connectivity. Using a single dual-channel composite radio reduces costs and conserves resources.

An aspect of the present disclosure provides an access point device for providing 6 GHz connectivity. The access point device comprises a dual-channel composite radio, the dual channel composite radio comprising a front-end module (FEM), a 6 GHz antenna connected to the FEM, a summation circuit, wherein the summation circuit receives a first transmit signal and a second transmit signal and outputs a transmit output signal to the FEM, a bandpass filter, wherein the bandpass filter receives a receive input signal from the FEM when the FEM is in a receive state and outputs a first receive signal and a second receive signal, and wherein 6 GHz connectivity is provided by the FEM sending the transmit output signal to the 6 GHz antenna when in a transmit state and receiving the receive input signal from the 6 GHz antenna when in the receive state.

In an aspect of the present disclosure, the first receive signal is output from a high band side of the bandpass filter and the second receive signal is output from the low band side of the bandpass filter.

In an aspect of the present disclosure, the 6 GHz antenna sends the first transmit signal to a network device via a 6 GHz backhaul connection and the second transmit signal to a client device via a 6 GHz fronthaul connection.

In an aspect of the present disclosure, the 6 GHz antenna receives the first receive signal from a network device and the second receive signal from a client device.

In an aspect of the present disclosure, wherein the access point device comprises a plurality of radio chains, the 6 GHz antenna comprises a plurality of 6 GHz antennas, wherein the summation circuit comprises a plurality of summation circuits, the bandpass filter comprises a plurality of bandpass filters, and the FEM comprises a plurality of FEMS, wherein each of the plurality of radio chains comprises a corresponding 6 GHz antenna of the plurality of 6 GHz antennas, a corresponding summation circuit of the plurality of the summation circuits, a corresponding bandpass filter of the plurality of bandpass filters, and a corresponding FEM of the plurality of FEMS.

In an aspect of the present disclosure, the plurality of radio chains comprises four radio chains.

In an aspect of the present disclosure, the plurality of radio chains comprise three radio chains.

An aspect of the present disclosure provides a method for an access point device comprising a dual-channel composite radio for providing 6 GHz connectivity. The method comprises receiving, at a summation circuit of the dual-channel composite radio, a first transmit signal and a second transmit signal, outputting, by the summation circuit, a transmit output signal to a front-end module (FEM) of the dual-channel composite radio connected to a 6 gigahertz (GHz) antenna of the dual-channel composite radio, receiving, by a bandpass filter of the dual-channel composite radio, a receive input signal from the FEM when the FEM is in a receive state and outputs a first receive signal and a second receive signal, and providing 6 GHz connectivity by the FEM sending the transmit output signal to the 6 GHz antenna when in a transmit state and receiving the receive input signal from the 6 GHz antenna when in the receive state.

In an aspect of the present disclosure, the method is such that the first receive signal is output from a high band side of the bandpass filter and the second receive signal is output from the low band side of the bandpass filter.

In an aspect of the present disclosure, the method is such that the 6 GHz antenna sends the first transmit signal to a network device via a 6 GHz backhaul connection and the second transmit signal to a client device via a 6 GHz fronthaul connection.

In an aspect of the present disclosure, the method is such that the 6 GHz antenna receives the first receive signal from a network device and the second receive signal from a client device.

In an aspect of the present disclosure, the method is such that the dual-channel composite radio comprises a plurality of radio chains, the 6 GHz antenna comprises a plurality of 6 GHz antennas, wherein the summation circuit comprises a plurality of summation circuits, the bandpass filter comprises a plurality of bandpass filters, and the FEM comprises a plurality of FEMS, wherein each of the plurality of radio chains comprises a corresponding 6 GHz antenna of the plurality of 6 GHz antennas, a corresponding summation circuit of the plurality of the summation circuits, a corresponding bandpass filter of the plurality of bandpass filters, and a corresponding FEM of the plurality of FEMS.

In an aspect of the present disclosure, the method is such that the plurality of radio chains comprises four radio chains.

In an aspect of the present disclosure, the method is such that the plurality of radio chains comprises four radio chains.

An aspect of the present disclosure provides a non-transitory computer-readable medium of an access point device comprising a dual-channel composite radio for providing 6 GHz connectivity, storing one or more instructions. The one or more instructions when executed by a processor of the access point device, cause the access point device to perform one or more operations including the steps of the methods described above.

Thus, according to various aspects of the present disclosure described herein, it is possible for a connectivity system to provide a low latency 6 GHz connection to a network device, such as an augmented reality device, so as to deliver content to the network device such that the user experiences an improved QoS.

### BRIEF DESCRIPTION OF DRAWINGS

In the drawings, like reference numbers generally indicate identical, functionally similar, and/or structurally similar elements.

FIG. 1 is a schematic diagram of a network environment, according to one or more aspects of the present disclosure;

FIG. 2 is a more detailed block diagram illustrating various components of a network device, according to one or more aspects of the present disclosure;

FIG. 3 is an illustration of an access point device for providing a low latency 6 GHz connection to an AR client device in a network, according to one or more aspects of the present disclosure;

FIG. 4 is a block diagram illustrating an access point device with a dual-channel composite radio, according to one or more aspects of the present disclosure;

FIG. 5 is a time domain illustration for a dual-channel composite radio, according to one or more aspects of the present disclosure; and

FIG. 6 is a flow chart illustrating a method for providing a notification to a contact based on a profile configuration associated with a client user, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

Wi-Fi management is a subset of quality of experience (QoE) management. An access point device, according to one or more aspects of the present disclosure, can provide a 6 GHz network for providing a low latency and high bandwidth connection between the access point device and another network device, such as an altered reality (AR) device, for example an extended reality headset or gaming system.

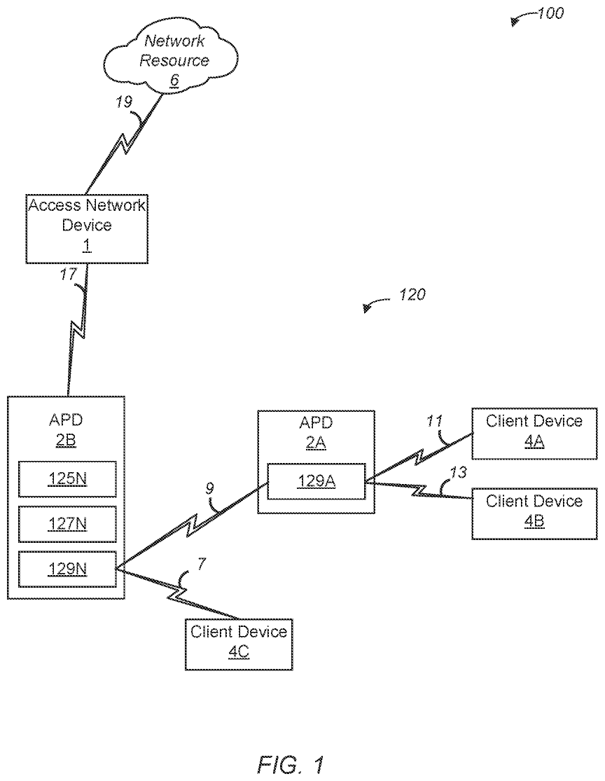

FIG. 1 is a schematic diagram of a network environment 100 that comprises a network 120 that comprises one or more network devices, according to one or more aspects of the present disclosure. It should be appreciated that various example embodiments of inventive concepts disclosed herein are not limited to specific numbers or combinations of devices, and there may be one or multiple of some of the aforementioned devices in the system, which may itself consist of multiple communication networks and various known or future developed wireless connectivity technologies, protocols, devices, and the like.

The network environment 100 includes one or more network devices, such as any of a network resource 6 (for example, any of an Internet Service Provider, the Internet, a regulatory domain, a repository, a web page, a server, a network service, any other resource that provides content, or any combination thereof), an access network device 1 (for example, any of a Passive Optical Network (PON) Optical Line Terminal (OLT), a Data Over Cable Service Interface Specification (DOCSIS) Cable Modem Termination System (CMTS), any other device that provides data service, or any combination thereof), a network 120, or any combination thereof. The network 120 can comprise one or more network devices, such as any of one or more access point devices (APD) (such as APD 2A and APD 2B, collectively referred to as access point device(s) 2), one or more client devices 4 (for example, client devices 4A, 4B and 4C, collectively referred to as client device(s) 4)), or any combination thereof that may be connected in one or more wireless networks (for example, a private network, a guest network, an iControl, a backhaul network, or an Internet of things (IoT) network), any other network devices, or any combination thereof. One or more network devices could be located in more than one network.

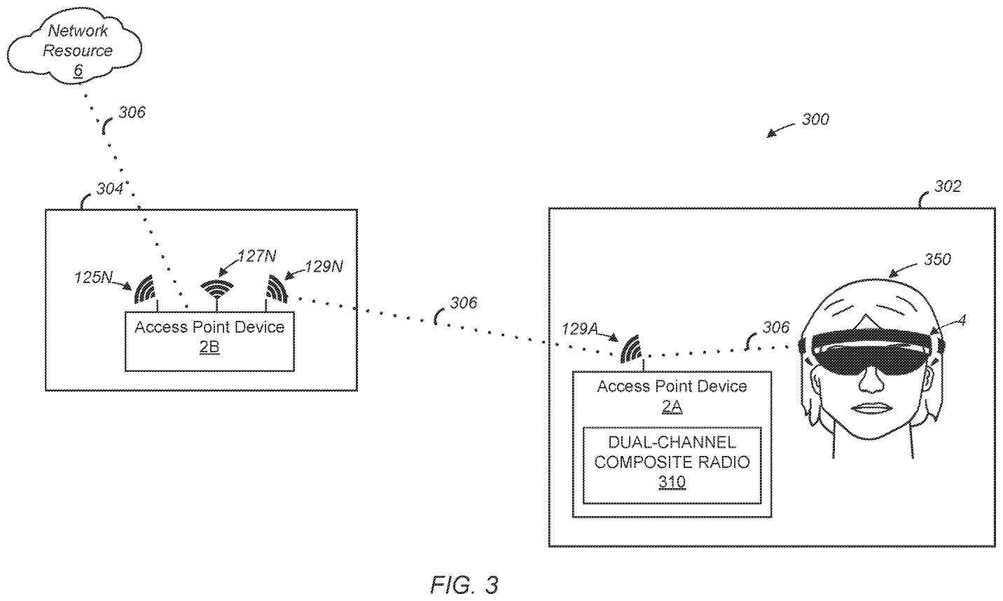

The access point device 2 can be, for example, a hardware electronic device that may be a combination modem and network gateway device that combines the functions of a modem, an access point (AP), a gateway, a residential gateway (RG), a broadband access gateway, a home network gateway, a router, a home router, an extender, or any combination thereof. It is also contemplated by the present disclosure that the access point device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The access point devices 2A and 2B can include one or more wireless interfaces. For example access point device 2B can comprise one or more radios such as a 2.4 GHz radio 125N, a 5 GHz radio 127N, and a 6 GHz radio 129N and access point device 2A can comprise one or more radios such as a first 6 GHz radio 129A and a second 6 GHz radio 129B. While FIG. 1 illustrates various radios collectively referred to as radios 125, 127, and 129, the present disclosure contemplates that any access point device 2 can comprise any number of radios at any given frequency, such as a 60 GHz radio. In one or more embodiments, a single access point device 2A is disposed or positioned at or about a client device 4A so as to provide AR content, such as XR content, from a network resource 6 to the client device 4A. The access point device 2A can comprise a dual-channel composite radio 310 as discussed with reference to FIG. 3 to provide a low latency 6 GHz channel for a first client device 4A and another 6 GHz channel to another or second client device 4B using a single radio.

The connections 7, 9, 11, 13, 17 and 19 between any one or more network devices can be implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizen broadband radio services (CBRS) band, 2.4 GHz frequency bands, 5 GHz frequency bands, 6 GHz frequency bands, 60 GHz frequency bands, any other bands, or any combination thereof. In one or more embodiments, any of connections 7, 9, 10, 11, 13, 15, 17 and 19 can be a wired connection. The connections 7 and 9 between an access point device 2A and a client device 4C and an access point device 2B, respectively, can be implemented using a radio 129N to establish a connection 9 to a radio 129A of the access point device 2A and a radio 129N to establish a connection to the client device 4C. Additionally, any one or more connections 7, 9, 10, 11, 13, 15, 17 and 19 can be implemented using a wireless connection that operates in accordance with, but is not limited to, RF4CE protocol, ZigBee protocol, Z-Wave protocol, or IEEE 802.15.4 protocol. It is also contemplated by the present disclosure that any one or more connections can include connections to a media over coax (MoCA) network.

The network 120 can comprise one or more client devices 4, for example, client devices 4A, 4B and 4C. A client device 4 can include a radio such as any of the radios discussed above with respect to access point device 2. The client devices 4 can be any AR client device, for example, any of a HMD XR device, an immersive technology device, any other virtual, augmented, extended, and/or altered reality device, or any combination thereof. A client device 4 can also be referred to as a station. Additionally, a client device 4 can receive AR content from a network resource 6 via an access point device 2. As an example, a client device 4A can be a first AR client device connected to APD 2A via a connection 11, client device 4B can be a second AR client device connected to APD 21 via a connection 13, and client device 4C can be a third AR client device connected to APD 2B via a connection 7. APD 2A and APD 2B can be connected via a 6 GHz radio 129N and a 6 GHz radio 129A so as to establish a 6 GHz BH connection. The APD 2A can use a 6 GHz radio 129B to establish a 6 GHz fronthaul (FH) connection to client devices 4A and/or 4B.

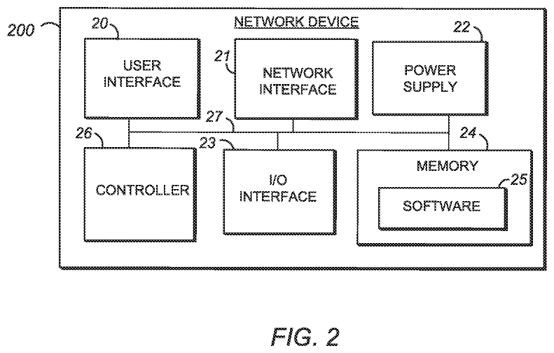

A more detailed description of the exemplary internal components of any one or more network devices shown in FIG. 1 will be provided in the discussion of FIG. 2. However, in general, it is contemplated by the present disclosure that any of the one or more network devices include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium (for example, a non-transitory computer-readable medium).

Further, any, all, or some of the computing components of the one or more network devices may be adapted to execute any operating system, including Linux, UNIX, Windows, MacOS, DOS, and Chrome OS as well as virtual machines adapted to virtualize execution of a particular operating system, including customized and proprietary operating systems. Any of the network devices are further equipped with components to facilitate communication with other network devices over the one or more network connections to local and wide area networks, wireless and wired networks, public and private networks, and any other communication network enabling communication in the system.

FIG. 2 is a more detailed block diagram illustrating various components of a network device 200, according to one or more aspects of the present disclosure. The network device 200, such as an access point device 2 discussed with reference to FIG. 1, comprises one or more internal components, such as a user interface 20, a network interface 21, a power supply 22, a controller 26, an input/output (I/O) interface 23, a memory 24, and a bus 27 interconnecting the one or more elements.

The power supply 22 supplies power to the one or more internal components of the network device 200 through the internal bus 27. The power supply 22 can be a self-contained power source such as a battery pack with an interface to be powered through an electrical charger connected to an outlet (for example, either directly or by way of another device). The power supply 22 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The user interface 20 includes, but is not limited to, push buttons, a keyboard, a keypad, a controller (such as a game controller and/or remote control), a liquid crystal display (LCD), a thin film transistor (TFT), a light-emitting diode (LED), a sensor (such as a motion sensor for detection of any of a gaze, an eye movement, a hand gesture, any other movement of a user, or any combination thereof), a high definition (HD) or other similar display device including a display device having touch screen capabilities so as to provide an interactive user experience, for example, for configuring an access point device 2. The network interface 20 can include, but is not limited to, various network cards, interfaces, and circuitry implemented in software and/or hardware to enable communications with and/or between any other network device.

The memory 24 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical storage system, a hard disk or any other various layers of memory hierarchy. The memory 24 can be used to store any type of instructions, software, or algorithms including software 25, for example, to provide configuration and manage operation of an access point device 2.

The controller 26 controls the general operations of the network device 200 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 25 which can include one or more instructions that when executed perform any one or more methods or steps in accordance with one or more embodiments. Communication between the components (for example, 20-25) of the network device 200 may be established using an internal bus 27.

The network interface 21 can include various network cards, interfaces, and circuitry implemented in software and/or hardware to enable communications with any one or more other network devices. For example, the network interface 21 can include multiple radios or sets of radios (for example, one or more 2.4 GHz radios, one or more 5 GHz radios, and/or one or more 6 GHz radios), which may also be referred to as wireless local area network (WLAN) interfaces. In one or more embodiments, an access point device comprises a dual-channel composite radio so as to provide a 6 GHz channel to a client device 4, such as an AR device.

The I/O interface 23 may include various network cards, and circuitry implemented in software and/or hardware to enable communications with a user and/or a client device 4.

FIG. 3 is an illustration of an access point device 2B for providing a low latency 6 GHz connection to a client device 4, such as an AR client device, for example, an XR headset, in a network 300, according to one or more aspects of the present disclosure. A network 300 can be the same as or similar to a network 120 as discussed with reference to FIG. 1. The access point device 2B can comprise a plurality of radios and can be disposed or located in and/or at a first location 304, for example, a living room, while access point device 2A can disposed or located at a second location 302, for example, a media room. A user 350 can also be disposed or located in the media room 302. An AR client device 4 can be on or about the user 350 so that the user 350 can experience an interactive AR experience.

A network resource 6 can transmit an AR content 306 to the access point device 2B, for example, an access point device that comprises a gateway and/or router for the network 300. The access point device 2B can send or transmit the AR content 306 via a radio 129N to the access point device 2A. The access point device 2A can receive the AR content 306 at a radio 129A (a 6 GHz radio) of the access point device 2A and can send or transmit the AR content 306 to the AR client device 4 via the 6 GHz radio 129A.

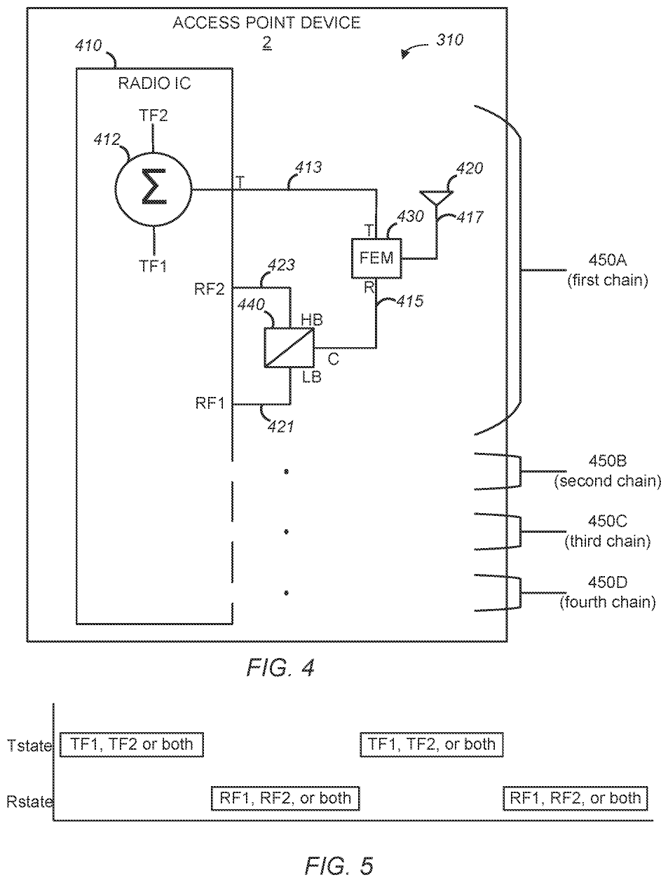

The access point device 2A can comprise a dual-channel composite radio 310 that utilizes a 6 GHz radio to provide both a 6 GHz backhaul connection for communications to an access point device 2B and a fronthaul connection to a client device 4 so as to provide one or more client services that require low latency, such as an AR content 306 sent to client device 4, for example, an XR headset that provides AR simulations and/or services to a user 350. For example, typical solutions provide an access point device having two 6 GHz radios with each radio having corresponding front-end modules (FEMs) with 6 GHz bandpass filters connected between the FEMs and the antennas. In contrast, one or more novel solutions of the present disclosure provide an access point device, such as access point device 2A, that comprise a dual-channel composite radio 310 as discussed with reference to FIG. 4.

While FIG. 3 illustrates access point devices 2B and 2A, the present disclosure contemplates a site or premises that comprises any number of access point devices including, but not limited to, a single access point device connected to a client device 4.

FIG. 4 is a block diagram illustrating an access point device 2 with a dual-channel composite radio 310, according to one or more aspects of the present disclosure. The access point device 2 provides for a reduced cost while providing a required QoE/QoS. The access point device 2 can include one or more elements or components as discussed with reference to a network device 200 of FIG. 2 while also comprising a dual-channel composite radio 310. The dual-channel composite radio 310 provides for 6 GHz fronthaul and backhaul connections using only a single radio.

The dual-channel composite radio 310 for a first chain 450A (and likewise for a second chain 450B, a third chain 450C and a fourth chain 450D) comprises a radio integrated circuit (IC) 410, a 6 GHz antenna 420, a FEM 430, and a band pass filter 440. The radio IC 410 can comprise a summation circuit 412 that receives as an input a first transmit signal (TF1) associated with a 6 GHz backhaul connection between the access point device 2 and another network device (for example, between an access point device 2A and an access point device 2B as discussed with reference to FIG. 1) and a second transmit signal (TF2) associated with a 6 GHz fronthaul connection between the access point device 2 and a client device 4, for example, an access point device 2A and an AR client device 4 as discussed with reference to FIG. 3. TF1 and TF2 are independent of each other and are summed (as T) by the summation circuit 412 in a digital domain. The summation circuit 412 outputs a transmit output signal 413 (denoted as T) to a FEM 430. The bandpass filter 440 outputs at a low band side (LB) a first receive signal 421 (to RF1 port of radio IC 410) associated with the 6 GHz backhaul connection and at a high band side (HB) a second receive signal 423 (to RF2 port of radio IC 410) associated with the fronthaul connection.

The FEM 430 either receives as an input a signal 417 from the antenna or transmits as a signal 417 the transmit output signal 413. For example, the bandpass filter 440 receives a receive input signal 415 from the FEM 430. The receive input signal 415 can comprise a signal associated with the fronthaul connection, the backhaul connection, or both. The bandpass filter 440 can pass the signal associated with the fronthaul connection as the first receive signal 421 on the low band side and the second receive signal associated with the backhaul connection as the second receive signal 423 on the high band side. As another example, the FEM 430 sends the transmit output signal 413 to the antenna 420 as signal 417 with the transmit output signal 413 comprising the output of summation circuit 412.

The dual-channel composite radio 310 illustrated in FIG. 4 is for a 4×4 chain radio such that the components or elements discussed for a first chain 450A also apply likewise to a second chain 450B, a third chain 450C and a fourth chain 450D. In one or more other embodiments, the dual-channel composite radio 310 is for a 4×4 chain radio (as illustrated), a 3×3 chain radio, a 2×2 chain radio, or a 1×1 chain radio. In one or more embodiments, the FEMs 430 associated with a first chain 450A, a second chain 450B, and a third chain 450C can be assigned to a first channel that operates asynchronously with a second channel with the difference being that the first channel with three assets (three dual-channel composite radios) assigned will experience better performance, such as better carrier to noise performance and better bit rate performance, than the second channel with only one asset assigned. For example, the first channel can be assigned permanently to the backhaul connection while the second channel is assigned for the fronthaul connection to the client device 4. In such an example, MAC management is performed in the time domain to ensure that do not have overlapping transmit signals with receive signals.

FIG. 5 is a time domain illustration for a dual-channel composite radio 310, according to one or more aspects of the present disclosure. A single dual-channel composite radio 310 schedules both transmit and receive signals so that the transmit signals do not overlap with the receive signals. For example, to maintain 320 megahertz (MHz) or a normal channel, unlicensed national information infrastructure (U-NII)-5 and U-NII-6 make up the lower channel (for a backhaul connection) while U-NII-7 and U-NII-8 make up the fronthaul connection for a client device 4, such as an AR client device 4.

The dual-channel composite radio 310 is either in a receive state (Rstate) or a transmit state (Tstate). When the dual-channel composite radio 310 is operating in the receive state, a first data (RF1), a second data (RF2), or both via the backhaul connection can be received from a network device. After receiving, for example, the first receive data (RF1), the second receive data (RF2), or both, the dual-channel composite radio 310 can transition or switch to the transmit state and send a first transmit data (TF1) to the AR client device 4 via the fronthaul connection, a second transmit data (TF2) to the network device via the backhaul connection, and/or the first transmit data TF1 followed by the second transmit data TF2 (as illustrated in FIG. 5). The dual-channel composite radio 310 can then switch back to the receive state and receive additional first data RF1, additional second data RF2, or both from the AR client device 4 via the fronthaul connection. Next, the dual-channel composite radio 310 can switch to the transmit state so as to transmit a respective additional first transmit data TF1 from the network device via the backhaul connection followed by a respective additional second transmit data TF2 from the AR client device 4 via the fronthaul connection. The process can continue alternating between the receive state (Rstate) and the transmit state (Tstate).

For a 4×4 full switching dual-channel composite radio configuration, the one or more acknowledgements (Acks) for the one or more received signals associated with RF1 and/or RF2 are suppressed until after the signals are appropriately forwarded into the other channel. The default state is the receive state for eight channels. As both of the allowable MACs for the 6 GHz spectrum permit scheduled airtime access for transmit and receive, maintaining exclusive airtime windows for these functions is straightforward.

While FIG. 5 illustrates a sequence of the dual-channel composite radio switching between transmit and receive states, the present disclosure contemplates that any number of sequences of switching between the transmit and receive states with any corresponding data being received and/or transmitted.

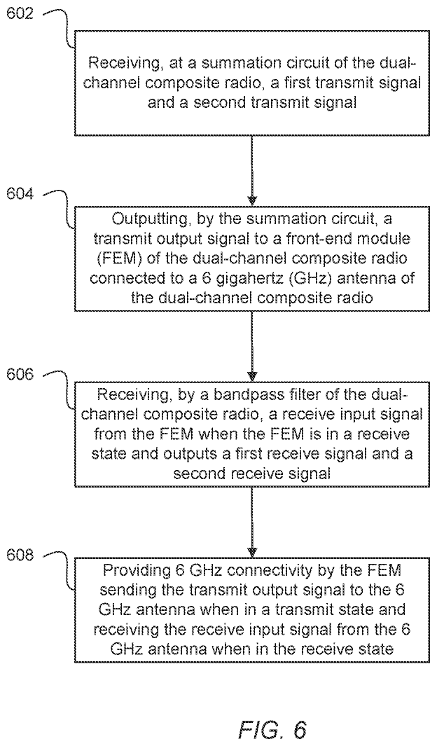

FIG. 6 is a flow chart for a network device, such as an access point device 2 that comprises a dual-channel composite radio 310, for providing 6 GHz connectivity, according to one or more aspects of the present disclosure. In FIG. 6, it is assumed that the access point device 2 includes a controller and/or a processor and software (such as one or more computer-readable instructions) stored in their respective memories, as discussed above in reference to FIGS. 1-5, which when executed by their respective controllers perform one or more functions or operations in accordance with the example embodiments of the present disclosure.

A processor, for example a controller or processor 26 of a network device, such as access point device 2 comprising dual-channel composite radio 310, can execute one or more computer-readable instructions, stored in a non-transitory computer-readable memory, for example, a memory 24 of an access point device, that when executed by the processor 26 performs and/or causes the access point device to perform one or more of the operations of steps 602-608 In one or more embodiments, the one or more computer-readable instructions may be one or more software applications, for example software 25. While the steps 602-608 are presented in a certain order, the present disclosure contemplates that any one or more steps can be performed simultaneously, substantially simultaneously, repeatedly, in any order or not at all (omitted).

At step 602, the summation circuit 412 of the dual-channel composite radio 310 receives a first transmit signal and a second transmit signal. In one or more aspects, a radio IC 410 of the dual-channel composite radio 310 comprises the summation circuit 412. The summation circuit 412 can comprise a plurality of summation circuits 412. The first transmit signal (TF1) can be associated with a 6 GHz backhaul connection between the access point device 2 and another network device 200, such as another access point device 2. The second transmit signal (TF2) can be associated with 6 GHz fronthaul connection between the access point device 2 and yet another network device, such as client device 4. For example, a 6 GHz antenna 420 can send the first transmit signal (TF1) to a network device 200 via a 6 GHz backhaul connection and the second transmit signal (TF2) to a client device 4 via a 6 GHz fronthaul connection.

At step 604, the summation circuit 412 outputs a transmit output signal 413 to a FEM 430 of the dual-channel composite radio 310 connected to a 6 GHz antenna 420 of the dual-channel composite radio 310. According to one or more aspects of the present disclosure, the dual-channel composite radio 420 comprises a plurality of radio chains 450 and each 6 GHz antenna 420 can comprise a plurality of 6 GHz antennas 420.

At step 606, a bandpass filter 440 of the dual-channel composite radio 310 receives a receive input signal from the FEM 430 when the FEM 430 is in a receive state and outputs based on the receive input signal a first receive signal 421 and a second receive signal 423. For example, the bandpass filter 440 can output at a low band side the first receive signal 421 to RF1 port of radio IC 410 associated with the 6 GHz backhaul connection and at a high band side the second receive signal 423 to RF2 port of radio IC 410 associated with the fronthaul connection. For example, the 6 GHz antenna 420 can receive the first receive signal 421 from a network device 200 and the second receive signal 423 from a client device 4. The bandpass filter 440 can comprise a plurality of bandpass filters 440 and the FEM can comprise a plurality of FEMS 430.

At step 608, the FEM 430 provides 6 GHz connectivity by sending the transmit output signal 413 (as signal 417) to the 6 GHz antenna 420 when in a transmit state and receiving the receive input signal 415 (as signal 417) from the 6 GHz antenna 420 when in the receive state.

According to one or more aspects of the present disclosure, each of a plurality of radio chains can comprise a corresponding 6 GHz antenna 420 of a plurality of 6 GHz antennas 420, a corresponding summation circuit 412 of a plurality of a summation circuits 412, a corresponding bandpass filter 440 of a plurality of bandpass filters 440, and a corresponding FEM 430 of a plurality of FEMS 430. Any one or more of the radio chains 450 can comprise four radio chains or three radio chains.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. An access point device for providing 6 Gigahertz (GHz) connectivity comprising:
a dual-channel composite radio, the dual channel composite radio comprising:
a front-end module (FEM);
a 6 GHz antenna connected to the FEM;
a summation circuit, wherein the summation circuit receives a first transmit signal and a second transmit signal and outputs a transmit output signal to the FEM;
a bandpass filter, wherein the bandpass filter receives a receive input signal from the FEM when the FEM is in a receive state and outputs a first receive signal and a second receive signal; and
wherein 6 GHz connectivity is provided by the FEM sending the transmit output signal to the 6 GHz antenna when in a transmit state and receiving the receive input signal from the 6 GHz antenna when in the receive state.

2. The access point device of claim 1, wherein the first receive signal is output from a high band side of the bandpass filter and the second receive signal is output from the low band side of the bandpass filter.

3. The access point device of claim 1, wherein the 6 GHz antenna sends the first transmit signal to a network device via a 6 GHz backhaul connection and the second transmit signal to a client device via a 6 GHz fronthaul connection.

4. The access point device of claim 1, wherein the 6 GHz antenna receives the first receive signal from a network device and the second receive signal from a client device.

5. The access point device of claim 1, wherein the dual-channel composite radio comprises a plurality of radio chains, the 6 GHz antenna comprises a plurality of 6 GHz antennas, wherein the summation circuit comprises a plurality of summation circuits, the bandpass filter comprises a plurality of bandpass filters, and the FEM comprises a plurality of FEMS, wherein each of the plurality of radio chains comprises a corresponding 6 GHz antenna of the plurality of 6 GHz antennas, a corresponding summation circuit of the plurality of the summation circuits, a corresponding bandpass filter of the plurality of bandpass filters, and a corresponding FEM of the plurality of FEMS.

6. The access point device of claim 5, wherein the plurality of radio chains comprises four radio chains.

7. The access point device of claim 5, wherein the plurality of radio chains comprises four radio chains.

8. A method for an access point device comprising a dual-channel composite radio for providing 6 GHz connectivity, the method comprising:
receiving, at a summation circuit of the dual channel composite radio, a first transmit signal and a second transmit signal;
outputting, by the summation circuit, a transmit output signal to a front-end module (FEM) of the dual-channel composite radio connected to a 6 gigahertz (GHz) antenna of dual-channel composite radio;
receiving, by a bandpass filter of the dual-channel composite radio, a receive input signal from a FEM of the dual-channel composite radio when the FEM is in a receive state and outputs a first receive signal and a second receive signal; and
providing 6 GHz connectivity by the FEM sending the transmit output signal to the 6 GHz antenna when in a transmit state and receiving the receive input signal from the 6 GHz antenna when in the receive state.

9. The method of claim 8, wherein the first receive signal is output from a high band side of the bandpass filter and the second receive signal is output from the low band side of the bandpass filter.

10. The method of claim 8, wherein the 6 GHz antenna sends the first transmit signal to a network device via a 6 GHz backhaul connection and the second transmit signal to a client device via a 6 GHz fronthaul connection.

11. The method of claim 8, wherein the 6 GHz antenna receives the first receive signal from a network device and the second receive signal from a client device.

12. The method of claim 8, wherein the dual channel composite radio comprises a plurality of radio chains, the 6 GHz antenna comprises a plurality of 6 GHz antennas, wherein the summation circuit comprises a plurality of summation circuits, the bandpass filter comprises a plurality of bandpass filters, and the FEM comprises a plurality of FEMS, wherein each of the plurality of radio chains comprises a corresponding 6 GHz antenna of the plurality of 6 GHz antennas, a corresponding summation circuit of the plurality of the summation circuits, a corresponding bandpass filter of the plurality of bandpass filters, and a corresponding FEM of the plurality of FEMS.

13. The method of claim 12, wherein the plurality of radio chains comprises four radio chains.

14. The method of claim 12, wherein the plurality of radio chains comprise three radio chains.

15. A non-transitory computer-readable medium of an access point comprising a dual-channel composite radio for providing a 6 GHz connectivity, the one or more computer-readable instructions that when executed by a processor of the access point device cause the access point device to perform one or more operations comprising:
receiving, at a summation circuit of the dual-channel composite radio, a first transmit signal and a second transmit signal,
outputting, by the summation circuit, a transmit output signal to a front-end module (FEM) of the dual-channel composite radio connected to a 6 gigahertz (GHz) antenna of the dual-channel composite radio;
receiving, by a bandpass filter of the dual-channel composite radio, a receive input signal from a FEM of the dual-channel composite radio when the FEM is in a receive state and outputs a first receive signal and a second receive signal; and
providing 6 GHz connectivity by the FEM sending the transmit output signal to the 6 GHz antenna when in a transmit state and receives the receive input signal from the 6 GHz antenna when in the receive state.

16. The non-transitory computer-readable medium of claim 15, wherein the first receive signal is output from a high band side of the bandpass filter and the second receive signal is output from the low band side of the bandpass filter.

17. The non-transitory computer-readable medium of claim 15, wherein the 6 GHz antenna sends the first transmit signal to a network device via a 6 GHz backhaul connection and the second transmit signal to a client device via a 6 GHz fronthaul connection.

18. The non-transitory computer-readable medium of claim 15, wherein the 6 GHz antenna receives the first receive signal from a network device and the second receive signal from a client device.

19. The non-transitory computer-readable medium of claim 15, wherein the dual-channel composite radio comprises a plurality of radio chains, the 6 GHz antenna comprises a plurality of 6 GHz antennas, wherein the summation circuit comprises a plurality of summation circuits, the bandpass filter comprises a plurality of bandpass filters, and the FEM comprises a plurality of FEMS, wherein each of the plurality of radio chains comprises a corresponding 6 GHz antenna of the plurality of 6 GHz antennas, a corresponding summation circuit of the plurality of the summation circuits, a corresponding bandpass filter of the plurality of bandpass filters, and a corresponding FEM of the plurality of FEMS.

20. The non-transitory computer-readable medium of claim 19, wherein the plurality of radio chains comprises four radio chains or three radio chains.
